(19) United States
(12) Patent Application Publication
(10) Pub. No.: US 2010/0255184 A1
(43) Pub. Date: Oct. 7, 2010

(54) Film Deposition Apparatus and a Method of Manufacturing a Light Emitting Device Using the Apparatus

(75) Inventors: Shunpei Yamazaki, Tokyo (JP); Toshimitsu Konuma, Kanagawa (JP); Takeshi Fukunaga, Kanagawa (JP)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Semiconductor Energy Laboratory Co., Ltd.

(21) Appl. No.: 12/759,776

(22) Filed: Apr. 14, 2010

Related U.S. Application Data
(62) Division of application No. 09/724,002, filed on Nov. 28, 2000, now abandoned.

(30) Foreign Application Priority Data
Nov. 29, 1999 (JP) 11-337190

(51) Int. Cl. B05D 5/06

(52) U.S. Cl. 427/66

(57) ABSTRACT

To provide a film deposition apparatus capable of forming an EL element of high reliability. An oxidization cell (205) is placed in a liquid phase film deposition chamber (109) such as a spin coater. The oxidization cell is provided with an oxygen gettering agent (209) comprised of an element that belongs to Group 1 or 2 of the periodic table. The oxygen gettering agent (209) is oxidized consuming oxygen in the atmosphere of the chamber, to thereby reduce the oxygen concentration in the atmosphere to 1 ppb or less. This makes it possible to form an EL element in a substantially oxygen-less state, greatly improving the reliability of the EL element.

### BACKGROUND OF THE INVENTION

1. Field of the Invention

The present invention relates to a thin film deposition apparatus and a method of manufacturing a light emitting device using the apparatus, the apparatus being used for manufacturing an EL (Electro Luminescence) element composed of an anode, a cathode and an EL-providing luminescent material, especially a luminescent organic material (hereinafter referred to as organic EL material), sandwiched therebetween.

2. Description of the Related Art

In recent years, development has been made in display devices using an EL element (EL display devices) as an element that emits light on its own by utilizing the EL phenomenon of an organic EL material. Being capable of emitting light on their own, the EL display devices do not need any backlight unlike liquid crystal display devices. Furthermore, the EL display devices have a wide view angle, making them promising candidates for display units of portable instruments for outdoor use.

There are two types of EL display devices, namely, a passive type (passive matrix EL display devices) and an active type (active matrix EL display devices), both of which are being developed extensively. Of the two, the ones that attract greater attention now are the active matrix EL display devices. EL materials for forming a light emitting layer of an EL element are also divided into two types, i.e., organic materials and inorganic materials. The organic materials are further divided into low molecular type (monomer based) organic EL materials and high molecular type (polymer based) organic EL materials. Although equally intensive research is being conducted on both the monomer and polymer based organic EL materials, the polymer based EL organic materials receive attention more, for they are easier in handling and more resistive against heat than the low molecular type organic EL materials.

However, the organic EL materials readily change their molecular structure through oxidization, losing their ability of emitting light. In other words, a light emitting layer formed from an organic EL material is oxidized to deprive an EL element of its ability of emitting light and degrade the EL element. It is thus important in manufacturing an EL element of high reliability to remove oxygen (O₂) that accelerates oxidization of the organic EL material as much as possible after the organic EL material has been formed.

On the other hand, the low molecular type organic materials have no significant problem of oxygen being mixed in an EL element, for the low molecular organic EL materials are deposited in vacuum by evaporation. Because the EL element is not exposed to the air and is sealed in an air-tight space after the monomer based organic EL materials has been deposited, the EL element can be completed without exposing the EL element to the air, not even once, counting from the deposition step.

It is difficult to form a film from the high molecular type organic EL material in vacuum and, hence, deposition of the polymer based organic EL material is carried out in an inert gas such as nitrogen or rare gas by the ink jet method, spin coating or printing. The high molecular type organic EL materials are weak especially against oxygen, and are readily oxidized and degraded with a meager amount of oxygen. The degradation may be contained to a degree that raises no significant problem by reducing the oxygen concentration in the inert gas to 1 ppm or less. However, this is still insufficient to ensure a long term reliability.

### SUMMARY OF THE INVENTION

The present invention has been made in view of the above problem, and an object of the present invention is therefore to provide a method of enhancing the reliability of a light emitting device that uses a luminescent material. Another object of the present invention is to provide a film deposition apparatus for forming such a highly reliable light emitting device.

The present invention is characterized in that, prior to deposition of an EL material (in particular, an organic EL material), an element that belongs to Group 1 or 2 of the periodic table (an alkaline metal element or an alkaline earth metal element) is oxidized in a film deposition chamber to remove oxygen in the interior of the film deposition chamber. That is, the invention is characterized in that oxygen is chemically removed (gettered) by utilizing the nature of the alkaline metal element or the alkaline earth metal element, namely its being oxidized very easily.

To be specific, an element that belongs to Group 1 or 2 of the periodic table is placed in an oxidization cell that is set inside the film deposition chamber. The element that belongs to Group 1 or 2 of the periodic table is then oxidized in the oxidization cell. If the element used is the one that is not oxidized at room temperature, the oxidization cell is heated. If the element used is the one that is oxidized in room temperature, the element is sealed in the oxidization cell while keeping the element out of reach of oxygen by, for example, storing it in alcohol, and is oxidized after the cell is set in the film deposition chamber.

In carrying out the present invention, oxygen present in the film deposition chamber is consumed by oxidization reaction with the element that belongs to Group 1 or 2 of the periodic table during the course of oxidization of the element that belongs to Group 1 or 2 of the periodic table. This may be considered as gettering of oxygen by the element that belongs to Group 1 or 2 of the periodic table.

The present invention is carried out as an effective pre-processing in forming a film from a high molecular type organic EL material by a liquid phase method (the ink jet method, spin coating, printing, or dispensing). However, it is also possible to carry out the present invention as a pre-processing in forming a film from a low molecular organic EL material by a vapor phase method (evaporation or sputtering).

As described above, the oxidization reaction between the element that belongs to Group 1 or 2 of the periodic table and oxygen in the film deposition chamber is utilized as the pre-processing for depositing an EL material. The oxidization reaction reduces the oxygen concentration in the film deposition chamber to 1 ppb or less (preferably 0.1 ppb or less). As a result, the EL material can be deposited in an inert atmosphere having an oxygen concentration of 1 ppb or less (preferably 0.1 ppb or less). In other words, the EL element can be formed in a substantially oxygen-less state, providing an EL display device with a reliability higher than those of conventional devices.

### BRIEF DESCRIPTION OF THE DRAWINGS

In the accompanying drawings:

FIG. 1 is a diagram showing the structure of a film deposition apparatus;

FIGS. 2A and 2B are diagrams showing the structure of a liquid phase film deposition chamber;

FIGS. 3A to 3C are diagrams showing the structure of a liquid phase film deposition chamber;

FIGS. 4A and 4B are diagrams showing the structure of a liquid phase film deposition chamber;

FIGS. 5A to 5C are diagrams showing the structure of a head portion provided in a liquid phase film deposition chamber;

FIGS. 6A and 6B are diagrams showing the structure of a head portion provided in a liquid phase film deposition chamber;

FIGS. 7A to 7D are diagrams showing the structure of a head portion provided in a liquid phase film deposition chamber;

FIGS. 8A and 8B are diagrams showing the sectional structure of an EL display device; and

FIG. 9 is a diagram showing the sectional structure of an EL display device.

### DETAILED DESCRIPTION OF THE PREFERRED EMBODIMENTS

### Embodiment Mode

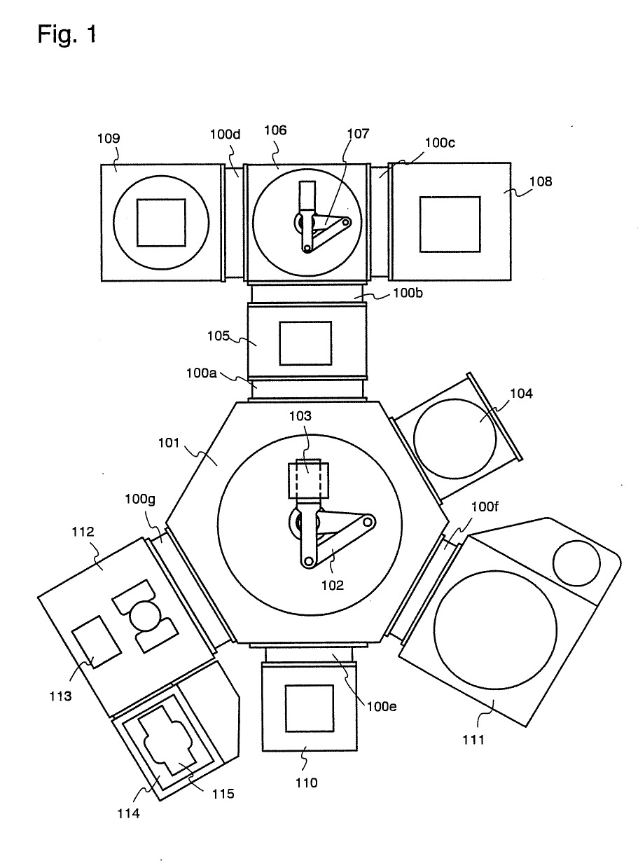

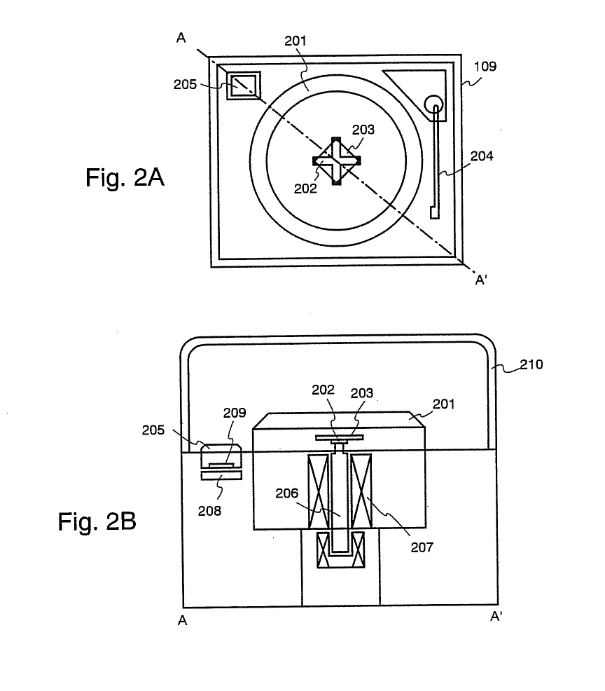

A film deposition apparatus of the present invention will be described with reference to FIG. 1 and FIGS. 2A and 2B. In FIG. 1, reference numeral 101 denotes a transferring chamber (A) provided with a transferring mechanism (A) 102 for transferring a substrate 103. The atmosphere of the transferring chamber (A) 101 is under reduced pressure and communication between the transferring chamber (A) and processing chambers is cut by gates. The transferring mechanism (A) 102 receives the substrate from, or hands out the substrate to, the respective processing chambers when the respective gates are opened. A discharging pump such as an oil rotary pump, a mechanical booster pump, a turbomolecular pump, or a cryo pump may be used to vacuum the transferring chamber (A) 101. Of the pumps mentioned above, a cryo pump is preferred, for it is effective in removing moisture.

The film deposition apparatus in FIG. 1 is provided with a discharging port 104 placed on a side of the transferring chamber (A) 101. The discharging pump is placed below the discharging port 104. This structure is advantageous in terms of easy maintenance of the discharging pump.

The respective chambers will be described below. Since the atmosphere of the transferring chamber (A) 101 is under reduced pressure, every processing chamber that is connected directly to the transferring chamber (A) 101 is provided with a discharging pump (not shown). Pump usable as this discharging pump include the oil rotary pump, the mechanical booster pump, the turbomolecular pump, and the cryo pump mentioned above.

Reference numeral 105 denotes a stock chamber for setting (placing) a substrate, and the stock chamber 105 is also called as a load lock chamber. Communication between the stock chamber 105 and the transferring chamber (A) 101 is cut off by a gate 100a. A carrier (not shown) in which a substrate 103 is set is placed in the stock chamber. The stock chamber may be partitioned to have a space where the substrate is loaded and a space where the substrate is unloaded. The stock chamber 105 is provided with the discharging pump described above and a purge line for introducing a highly pure nitrogen gas or rare gas.

In this embodiment mode, the substrate 103 is set face down in the carrier (so that the side on which an EL element is to be formed faces downward). This is for facilitating a later step of vapor phase deposition (deposition by sputtering or by evaporation) which employs the face down method (also called deposit up method). In the face down method, the deposition is performed while the side of the substrate on which the EL element is to be formed faces downward, thereby preventing a dust or the like from falling on the side for forming the EL element.

Reference numeral 106 denotes a transferring chamber (B), which is connected to the stock chamber 105 through a gate 100b and which is provided with a transferring mechanism (B) 107. Denoted by reference numeral 108 is a calcining chamber (baking chamber) which is connected to the transferring chamber (B) 106 through a gate 100c. The calcining chamber 108 has a mechanism for turning the substrate upside down. Specifically, this mechanism turn over the substrate that has been transferred in accordance with the face down method, thereby switching into the face up method. This enables the substrate to receive face up the next processing in a liquid phase film deposition chamber 109. After the processing in the liquid phase film deposition chamber 109 is completed, the substrate returns to the calcining chamber 108 to once more be calcined and turned over, thereby switching back to the face down method. Then the substrate returns to the stock chamber 105.

The liquid phase film deposition chamber 109 is connected to the transferring chamber (B) 106 through a gate 100d. The liquid phase film deposition chamber 109 is for forming a film containing an EL material by applying to the substrate a solution that contains the EL material. In the present invention, a high molecular type (polymer based) organic EL material is deposited in the liquid phase film deposition chamber 109. EL materials used here include not only the one for forming a light emitting layer but also a material for forming an electric charge injection layer, or an electric charge transporting layer. Any known high molecular type organic EL material may be used.

Typical organic EL materials for forming the light emitting layer include a PPV (polyparaphenylene vinylene) derivative, a PVK (polyvinyl carbazole) derivative, and a polyfluorene derivative. These are also called π conjugate polymers. Examples of the EL material for forming the electric charge injection layer include PEDOT (polythiophene) and PAni (polyaniline).

Now a detailed description will be given on the liquid phase film deposition chamber 109 with reference to FIGS. 2A and 2B. This embodiment shows an example in which a spin coater is used as the liquid phase film deposition chamber 109. Note that there is no need to limit the liquid phase film deposition chamber to the spin coater, and that the liquid phase film deposition chamber may be a film deposition chamber using dispensing, printing, or the ink jet method.

FIG. 2A is a top view of the liquid phase film deposition chamber 109. Reference numeral 201 denotes an application cup provided with a chuck 202 in the center. A substrate 203 transferred thereto is held by the chuck 202. An application nozzle is denoted by 204 and discharges an organic EL material from its tip.

According to the present invention, the liquid phase film deposition chamber 109 is further provided with an oxidization cell (oxidizing chamber) 205. This oxidization cell 205 is used in the present invention to oxidize (burn) therein a solid consisting of an element that belongs to Group 1 or 2 of the periodic table. Thus oxygen in the liquid phase film deposition chamber 109 is gettered (captured). If the gate 100d is closed at this point, the liquid phase film deposition chamber 109 is sealed air-tight to efficiently getter oxygen. The Group 1 element or the Group 2 element used herein for this purpose is hereinafter referred to as oxygen gettering agent.

FIG. 2B is a sectional view of the liquid phase film deposition chamber 109 cut along the line A-A′ of FIG. 2A. The chuck 202 is coupled to a rotary axis 206, which is driven by a control mechanism 207 serving as a bearing. A heater 208 is placed under the oxidization cell 205, so that the oxygen gettering agent 209 set in the oxidization cell 205 is heated and oxidized by the heater 208. Alternatively, electric current may be allowed to flow through the oxidization cell 205 itself, so that the oxygen gettering agent 209 is oxidized by resistance heating.

How long the oxygen gettering agent 209 is to be oxidized can be adjusted by opening and closing a lid that is provided near the entrance of the oxidization cell 205 and is capable of sealing the cell air-tight when closed. This is effective when using one of those element that spontaneously combust at room temperature (typically, sodium). To elaborate, prior to the deposition of the organic EL material, the oxygen gettering agent 209 is oxidized for a certain period of time. Then the lid is closed to seal the oxidization cell 205 air-tight and shut off oxygen supply, imperatively ending the oxidization process. When a substrate is again transferred to the chamber, the lid is opened and the oxidization of the oxygen gettering agent 209 is started. This operation is repeated to allow a plurality of substrates to be processed without replacing the oxygen gettering agent, making it possible to improve throughput in manufacture.

As described above, the film deposition apparatus shown in FIG. 1 has the liquid phase film deposition chamber 109 that is provided with the oxidization cell 205 and with a dust-proof hood 210 for sealing air-tight the liquid phase film deposition chamber 109. Oxygen in the atmosphere of the film deposition chamber thus can readily be removed by oxidizing an element that belongs to Group 1 or 2 of the periodic table within the oxidization cell 205. That is, the present invention makes it possible to deposit an organic EL material in an inert atmosphere having an oxygen concentration of 1 ppb or less (preferably 0.1 ppb or less).

By pressurizing such an inert atmosphere (preferably 2 to 3 atm.), the pressure within the liquid phase film deposition chamber 109 is increased and oxygen permeation is thus minimized.

Next, reference numeral 110 denotes a processing chamber for processing the surface of a cathode or an anode serving as a pixel electrode of the EL element (the chamber is hereinafter referred to as pre-processing chamber). Communication between the pre-processing chamber 110 and the transferring chamber (A) 101 is cut off by a gate 100e. Various configurations may be taken by the pre-processing chamber depending on a manufacturing process of the EL element. In this embodiment mode, the surface of the pixel electrode is irradiated with ultraviolet light so that the surface is heated to 100 to 120° C. The pre-processing as such is effective in processing the anode surface of the EL element.

Next will be described a vapor phase film deposition chamber, denoted by 111, for forming a conductive film or for depositing an organic EL material by evaporation or sputtering. The vapor phase film deposition chamber 111 is connected to the transferring chamber (A) 101 through a gate 100f. An evaporation chamber is employed as the vapor phase film deposition chamber 111 in this embodiment mode. The evaporation chamber can have a plurality of evaporation sources in its interior. The evaporation sources are evaporated by resistance heating or with an electron beam to form the film.

The conductive film formed in the vapor phase film deposition chamber 111 is used as a cathodic electrode of the EL element. To form the conductive film, a metal having a small work function is evaporated. Typically, the metal is an element that belongs to Group 1 or 2 of the periodic table (representatives of which include lithium, magnesium, cesium, calcium, potassium, barium, sodium, and beryllium), or a metal having a work function approximate to that of the elements mentioned above. Instead, aluminum, copper, or silver may be evaporated to form a conductive film having a low resistance. It is also possible to form a transparent conductive film from a compound of indium oxide and tin oxide, or a compound of indium oxide and zinc oxide by evaporation.

Any known EL material (especially low molecular type organic EL material) can be deposited in the vapor phase film deposition chamber 111. An EL material for the light emitting layer is typically Alq₃ (tris-8-quinolinolate aluminum complex) or DSA (distil allylene derivative). An EL material for the electric charge injection layer is typically CuPc (copper phthalocyanine), LiF (lithium fluoride), or acacK (Kalium acetylacetonate). An EL material for the electric charge transporting layer is typically TPD (tri-phenylamine derivative) or NPD (anthracene derivative).

The above EL materials may be coevaporated with a fluorescent substance (typically, coumarin 6, rubrene, Nile red, DCM, quinacridone, etc.). Any known fluorescent substance may be used in the coevaporation. It is also possible to coevaporate the EL materials and an element that belongs to Group 1 or 2 of the periodic table so that a part of the light emitting layer serves as the electric charge transporting layer or the electric charge injection layer. Just for clarification, coevaporation means evaporation in which two or more evaporation sources are simultaneously heated in order to mix different substances during deposition.

In either way, the deposition of the organic EL material or formation of the conductive film is performed in vacuum while communication between the vapor phase film deposition chamber 111 and the transferring chamber (A) 101 is cut off by the gate 100f. Note that the face down method (deposit up method) is employed in the deposition.

Next, reference numeral 112 denotes a sealing chamber (also called a glove box), which is connected to the transferring chamber (A) 101 through a gate 100g. Processing conducted in the sealing chamber 112 is for readying the EL element for the final step of sealing the EL element in an air-tight space. This processing gives the EL element fabricated protection against oxygen and moisture by mechanically sealing the EL element using a sealing material, or by sealing with a thermally curable resin or a UV curable resin.

Glass, ceramic, a metal, etc., may be used as the sealing material. However, if the light is to be emitted toward the sealing material side, the sealing material has to be light transmissive. The sealing material and the substrate with the EL element formed thereon are bonded to each other using a thermally curable resin or a UV curable resin, which is cured by heat treatment or ultraviolet light irradiation to form the air-tight space. It is effective to put a drying agent such as barium oxide in this air-tight space.

Alternatively, the space defined by the sealing material and the EL element may be filled with a thermally curable resin or a UV curable resin. In this case, it is effective to mix a drying agent such as barium oxide in the thermally curable resin or the UV curable resin.

In the film deposition apparatus shown in FIG. 1, the sealing chamber 112 has in its interior a mechanism 113 for irradiating ultraviolet light (hereinafter referred to as ultraviolet light irradiation mechanism). The ultraviolet light irradiation mechanism 113 emits ultraviolet light to cure the UV curable resin. Operations in the sealing chamber 112 may be conducted manually using gloves. However, automatic operation under computer control is preferred. When using the sealing material, the sealing chamber 112 preferably has incorporated therein a mechanism for applying a sealing agent as the ones used in the cell assembling step like liquid crystal devices (here, a thermally curable resin or UV curable resin), a mechanism for bonding the substrate, and a mechanism for curing the sealing agent.

The interior of the sealing chamber 112 may be vacuumed if a discharging pump is attached to the sealing chamber. In the case where the sealing step is automatically carried out through the operation of a robot, the reduced pressure in the sealing chamber prevents permeation of oxygen and moisture. Conversely, the interior of the sealing chamber 112 may be pressurized. In this case, the pressurization is achieved while purging with a highly pure nitrogen gas or rare gas, to thereby prevent intrusion of oxygen or the like from the outside air.

The sealing chamber 112 is connected to a hand over chamber (pass box) 114. The hand over chamber 114 is provided with a transferring mechanism (C) 115, which transfers the substrate to the hand over chamber 114 after the sealing of the EL element has been completed in the sealing chamber 112. The hand over chamber 114 can also be vacuumed if a discharge pump is attached thereto. The hand over chamber 114 is an accommodation for avoiding direct exposure of the sealing chamber 112 to the outside air, and this is the place where the substrate is taken out.

As has been described, the film deposition apparatus shown in FIG. 1 is capable of completely avoiding exposure of the EL element to the outside air up until the sealing of the EL element in the air-tight space is finished. Furthermore, the organic EL material is deposited in the liquid phase film deposition chamber 109 in an inert atmosphere having an oxygen concentration of 1 ppb or less, thereby forming the film in an almost oxygen-less state. These factors make it possible to manufacture an EL display device whose reliability is higher than in prior art.

### Embodiment 1

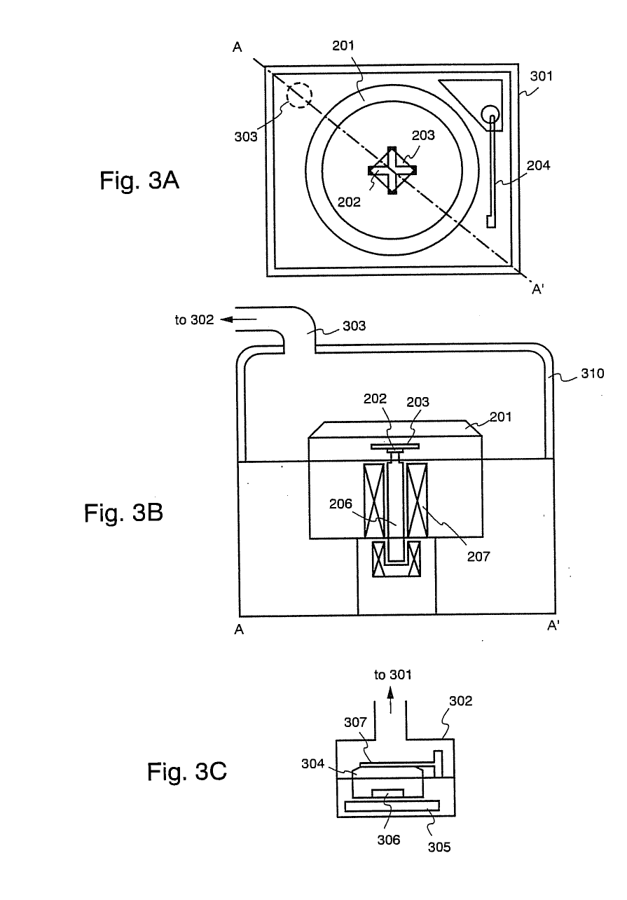

This embodiment describes, with reference to FIGS. 3A to 3C, an example of adopting a liquid phase film deposition chamber that has a structure different from the one in the liquid phase film deposition chamber 109 shown in FIG. 1. FIG. 3A is a top view of a liquid phase film deposition chamber 301. FIGS. 2A and 2B and FIGS. 3A to 3C share the application cup 201, the chuck 202, the substrate 203, and the application nozzle 204. The character of the film deposition apparatus shown in FIG. 3 resides in that an oxidization furnace 302 is provided outside the film deposition apparatus to replace the oxidization cell 205 of FIGS. 2A and 2B, and that the oxidization furnace 302 is connected to the liquid phase film deposition chamber 301 by piping 303.

Specifically, as shown in FIG. 3B, one port (suction port) of the piping 303 is provided in a part of a dust-proof hood 310, and the other port (discharge port) of the piping 303 is provided in the oxidization furnace 302.

The oxidization furnace 302 has, as shown in FIG. 3C, an oxidization cell 304, a heater 305, and an oxygen gettering agent 306 set within the oxidization cell 304. The oxygen gettering agent 306 is composed of an element that belongs to Group 1 or 2 of the periodic table. In this embodiment, a shutter 307 for shutting off supply of oxygen to the oxidization cell 304 is further provided.

In this embodiment, the oxygen gettering agent 306 is oxidized (burnt) within the oxidization furnace 302. Oxygen to be consumed at this point is supplied from the liquid phase film deposition chamber 301 through the piping 303, thereby reducing the oxygen concentration in the liquid phase deposition film chamber 301. The film deposition apparatus according to this embodiment is fundamentally different from the film deposition apparatus of FIG. 1 in that a heat source does not need to be placed near the film deposition apparatus of this embodiment. Management is easier if the heat source is apart from the apparatus of this embodiment, for the high molecular type organic EL material to be deposited in the liquid phase film deposition chamber 301 is dissolved into an organic solvent before being applied.

The liquid phase film deposition chamber 301 of this embodiment may be used as one of the film deposition chambers of the film deposition apparatus shown in FIG. 1.

### Embodiment 2

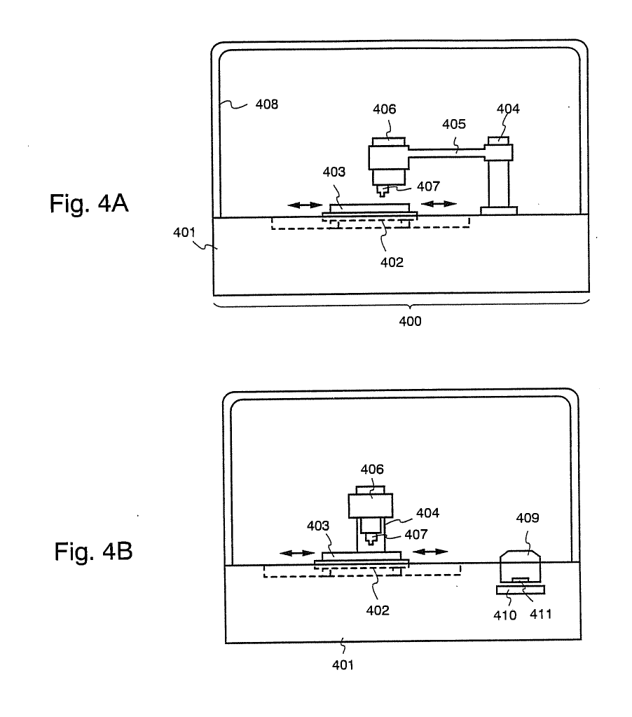

A description given in this embodiment is of an example in which a liquid phase film deposition chamber for forming stripes of red light emitting layers, green light emitting layers, and blue light emitting layers is provided in the film deposition apparatus of FIG. 1. The liquid phase film deposition chamber of this embodiment will be described with reference to FIGS. 4A and 4B.

FIG. 4A shows an appearance of a liquid phase film deposition chamber 400 of this embodiment, viewed from a side whereas FIG. 4B shows an appearance thereof viewed from the front. In FIG. 4A, reference numeral 401 denotes a support base and 402 denotes a transferring stage, onto which a substrate 403 is fixed. The transferring stage 402 is movable in the direction X (horizontal direction) and in the direction Y (vertical direction).

A support pillar 404 and a holder 405 are attached to the support base 401. An application unit 406 is set above the transferring stage 402. The application unit 406 is a device provided with a mechanism for applying to a substrate a solution that contains an organic EL material. The application unit 406 feeds a head portion 407 with a compressed gas (pressurized inert gas) and with the solution that contains an organic EL element. It is preferable for the application unit 406 to have a suck back mechanism (a mechanism including a suck back valve or an air operation valve). The suck back mechanism is a mechanism for sucking into the nozzle drops of solution which has been collected near the nozzle tip of the piping, by reducing the pressure within the piping utilizing a change in volume which is caused by a diaphragm gage or the like.

The application unit and the above other components are covered by a dust-proof hood 408 that is attached to the support base 401. The dust-proof hood 408 has an entrance for transferring the substrate. A gate is provided at the entrance to form an air-tight space between the support base 401 and the dust-proof hood 408.

An oxidization cell 409, a heater 410, and an oxygen gettering agent 411 are placed on the support base 401, and the oxygen gettering agent 411 is oxidized before the organic EL material is deposited.

In the liquid phase film deposition chamber 400 of FIGS. 4A and 4B, the head portion 407 is fixed while the transferring stage 402 carrying the substrate 403 moves in the direction X or in the direction Y. In other words, the head portion 407 moves above and relative to the substrate 403 by the movement of the transferring stage. Of course the head portion 407 itself may be moved. However, greater stability is obtained when moving the substrate, not the head portion.

According to the liquid phase film deposition chamber 400 structured as above, the head portion 407 provided with a nozzle for feeding an organic EL element (strictly speaking, it is a mixture obtained by dissolving the organic EL material in a solvent) moves above and relative to the substrate 403 to apply the organic EL material to a part of the substrate where the application is necessary. The process of applying the organic EL material by the head portion 407 will be described below.

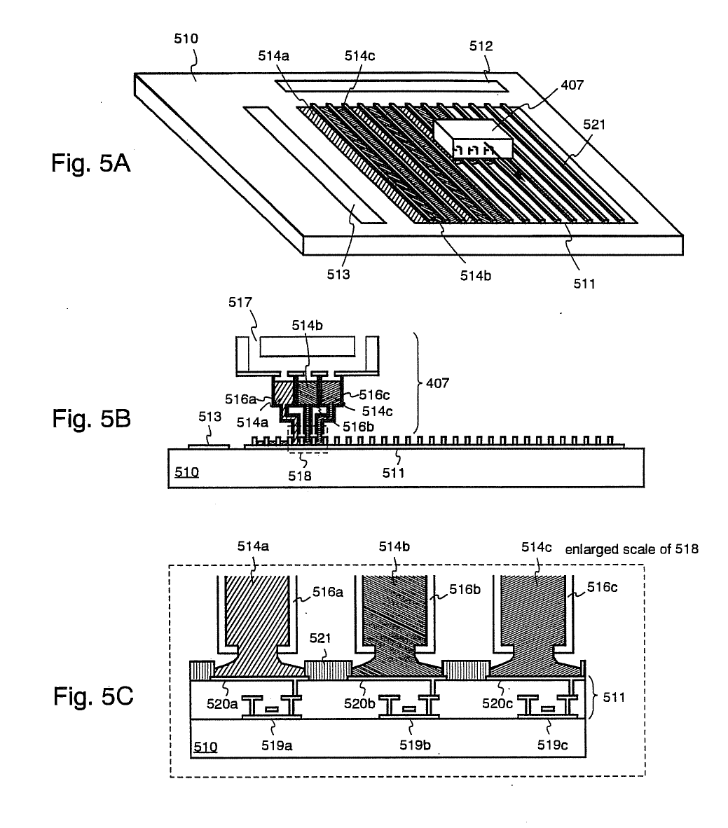

FIG. 5A is a diagram schematically showing how the present invention is carried out to deposit an organic EL material comprised of a π conjugate based polymer. In FIG. 5A, reference numeral 510 denotes a substrate on which a pixel portion 511, a source side driver circuit 512, and a gate side driver circuit 513 are formed from TFTs. A plurality of source wirings connected to the source side driver circuit 512 and a plurality of gate Airings connected to the gate side driver circuit 513 surround regions that serve as pixels. In each pixel, a TFT and an EL element that is electrically connected to the TFT are formed. A pixel portion 511 is composed of these pixels arranged in a matrix-like manner.

Reference numeral 514a denotes a mixture of a solvent and an organic EL material that emits red light when a voltage is applied thereto (hereinafter referred to as organic EL material (R)). The mixture will hereafter be called application solution (R). Reference numeral 514b denotes a mixture of a solvent and an organic EL material that emits green light when a voltage is applied thereto (hereinafter referred to as organic EL material (G)). The mixture will hereafter be called application solution (G). Reference numeral 514c denotes a mixture of a solvent and an organic EL material that emits blue light when a voltage is applied thereto (hereinafter referred to as organic EL material (B)). The mixture will hereafter be called application solution (B).

In preparing these organic EL materials, the present invention may take any of the following methods. One method is that a polymerized material is directly dissolved into a solvent and then the solution is applied. The other method is that a monomer dissolved into a solvent is deposited and then the film is polymerized by heat. This embodiment shows an example in which a polymerized organic EL material is dissolved in a solvent and then the solution is applied.

According to the present invention, the application solution (R) 514a, the application solution (G) 514b, and the application solution (B) 514c are discharged from the head portion 407 shown in FIGS. 4A and 4B and separately applied in the directions indicated by the arrows. This results in stripes of light emitting layers (strictly speaking, precursors of the light emitting layers) simultaneously formed in red light emitting pixel rows, green light emitting pixel rows, and blue light emitting pixel rows.

The pixel rows here mean rows of pixels with every adjacent rows being separated by a bank 521. Each bank 521 is formed above the source wiring. In other words, the pixel row is a row in which a plurality of pixels are lined up along the source wiring. Although the bank 521 is formed above the source wiring in the example shown here, it may be provided above the gate wiring. In that case, the pixel row is a row in which a plurality of pixels are lined up along the gate wiring.

Therefore, the pixel portion 511 can be deemed as an assembly of a plurality of pixel rows separated from one another by stripes of banks that are provided above a plurality of source wirings, or a plurality of gate wirings. From this point of view, it can be said that the pixel portion 511 consists of pixel rows where red light emitting layers are formed, pixel rows where green light emitting layers are formed, and pixel rows where blue light emitting layers are formed, with these three kinds of pixel rows together forming a striped pattern.

Also, the pixel portion 511 is substantially an assembly of a plurality of pixel rows separated from one another by a plurality of source wirings or a plurality of gate wirings, since the stripes of banks are formed above a plurality of source wirings or a plurality of gate wirings.

The head portion (i.e., application portion) 407 of FIG. 5A is enlarged in FIG. 5B.

The head portion 407 is provided with a red solution nozzle 516a, a green solution nozzle 516b, and a blue solution nozzle 516c. The nozzles have charged therein the application solution (R) 514a, the application solution (G) 514b, and the application solution (B) 514c, respectively. These solutions are pressurized by a compressed gas filling piping 517 to be pushed onto the pixel portion 511. The head portion 407 structured as above moves relative to the substrate along the depth of the drawing toward the near side to apply the solutions in a manner illustrated in FIG. 5A.

An area to which the solutions are being applied is denoted by 518 and enlarged in FIG. 5C. The pixel portion 511 provided on the substrate 510 is an assembly of pixels composed of TFTs 519a to 519c and pixel electrodes 520a to 520c. When pressurized by the compressed gas in the nozzles 516a to 516c in FIG. 5B, the application solutions 514a to 514c are pushed and discharged by the pressure.

The bank 521 made of a resin material is provided between adjacent pixels, thereby preventing mixing of the solutions of the adjacent pixels. In this structure, the width of the bank 521 (which is determined by the resolution of photolithography) is reduced to improve the degree of integration in the pixel portion, providing a high definition image. An application solution having a viscosity of 1 to 30 cp is particularly effective.

However, if the application solution has a viscosity of not less than 30 cp, or if it is not a solution but a gel or a sol, the banks are unnecessary. That is, if the angle of contact between the coated surface and the application solution put onto the surface is sufficiently large, the application solution do not spread too far. Accordingly, there is no need to hold the application solution by the banks. The final shape of the light emitting layer in the case where the banks are not formed is oblong (an elongated oval with the ratio of the longer diameter to the smaller diameter being 2 or more). Typically, it is an elongated oval extending from one end of the pixel portion to the other end thereof.

Resin materials usable in forming the bank 521 include an acrylic resin, polyimide, polyamide, and polyimideamide. If the resin material is blackened in advance by mixing therein carbon, black pigment, or the like, the bank 521 can be used also as a light shielding film between pixels.

A sensor that senses light reflection may be attached to the tip of the nozzle 516a, the nozzle 516b, or the nozzle 516c. This makes it possible to adjust the distance between the coated surface and the nozzles so that the distance is kept constant. A mechanism for adjusting the distance between the nozzles 516a and 516b and the distance between the nozzles 516b and 516c in accordance with the pixel pitch (distance between pixels) may be added thereto. Then the head portion can deal with any EL display device irrespective of its pixel pitch.

The application solutions 514a to 514c thus discharged from the nozzles 516a to 516c are applied so as to cover the pixel electrodes 520a to 520c, respectively. The operation of the head portion 407 as above is controlled with an electric signal.

After the application solutions 514a to 514c are applied, heat treatment is conducted in vacuum (baking or calcining) to volatilize the organic solvent contained in the application solutions 514a to 514c, thereby forming light emitting layers comprised of organic EL materials. The organic solvent to be used is therefore selected from ones that are volatilized at a temperature lower than a glass transition temperature (Tg) of the organic EL materials. The viscosity of the organic EL materials determine the thickness of the light emitting layers in their final forms. The viscosity may be adjusted by selecting a suitable organic solvent or by using additives. Preferable viscosity is 1 to 50 cp (more desirably, 5 to 20 cp).

The liquid phase film deposition chamber described as above is capable of simultaneously forming three kinds of light emitting layers which emit red light, green light, and blue light, respectively, thereby making it possible to form light emitting layers from polymer based organic EL materials with a high throughput. The throughput in this embodiment is very high because, unlike the ink jet method, a single application operation can apply a set of three application solutions to the substrate, forming three stripes of semiconductor layers at once.

That gettering oxygen in accordance with the present invention makes an EL element of high reliability is also the case with the liquid phase film deposition chamber of this embodiment. The liquid phase film deposition chamber of this embodiment may be used together with the liquid phase film deposition chamber described in Embodiment 1 (spin coater).

### Embodiment 3

Described in this embodiment is a liquid phase film deposition chamber having a head portion differently structured than the head portion explained in Embodiment 2 and shown in FIGS. 5A to 5C. As for components denoted by the same reference numerals as FIGS. 5A to 5C, refer to the descriptions in Embodiment 2.

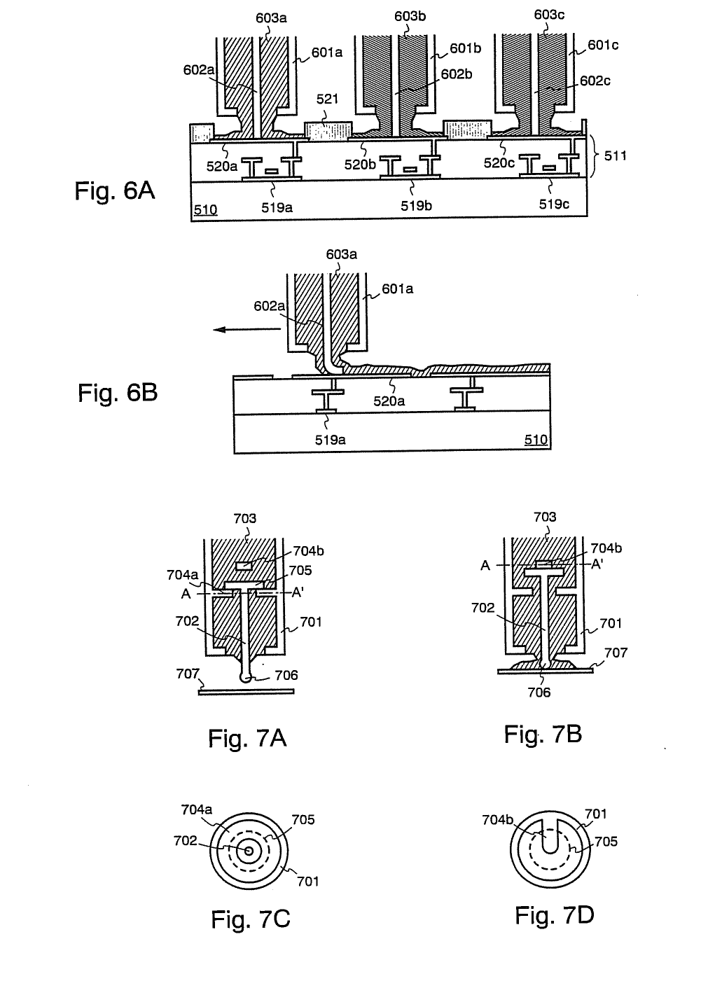

FIG. 6A shows the head portion of the liquid phase film deposition chamber of this embodiment. Nozzles 601a to 601c have therein rods 602a to 602c, respectively, the rods being coaxial to the nozzles. An application solution (R) 603a, an application solution (G) 603b, and an application solution (B) 603c are charged in the nozzles 601a to 601c, respectively. The rods 602a to 602c can prevent clogging of the nozzles due to solidified application solutions.

The inner walls of the nozzles 601a to 601c preferably repel the application solutions, and the surfaces of the rods 602a to 602c preferably absorb the application solutions. In order to make the inner walls of the nozzles 601a to 601c hydrophobic, the nozzles are formed from a hydrophobic material such as Teflon, PVDF (polyvinylidene fluoride), and a metal (typically, stainless steel, aluminum, and zirconium). In order to make the surfaces of the rods 602a to 602c hydrophilic, the rods are formed from a hydrophilic material, typical example of which is nylon or PVA (polyvinyl alcohol).

The solidification of the application solution (R) 603a, the application solution (G) 603b, and the application solution (B) 603c may also be prevented by forming the nozzles 601a to 601c from a metal and causing ultrasonic to propagate the nozzles 601a to 601c.

The application solution (R) 603a, the application solution (G) 603b, and the application solution (B) 603c are applied with the rods 602a to 602c being in contact with the deposition target surfaces (the surfaces of the pixel electrodes 520a to 520c in this embodiment). The rods 602a to 602c are formed from a very soft material, and move on the deposition target surfaces so as to rub against the surfaces. The movement of the rods is illustrated in FIG. 6B.

The nozzle 601a moves in the direction indicated by the arrow while the rod 602a is in contact with the pixel electrode 520a. The application solution (R) 603a thus slides down the rod 602a to be applied to the surface of the pixel electrode 520a. This method does not need to sprinkle the application solution as in the ink jet method and, hence, is free from the problem of inaccurate positioning in applying the solutions.

As described above, the liquid phase film deposition chamber provided with the head portion of this embodiment is capable of depositing the organic EL element in accordance with a fine pattern while solving the problem of nozzle clogging. Moreover, the film deposition chamber of this embodiment can make an EL element of high reliability by gettering oxygen in advance in accordance with the manner of the present invention.

The structure of this embodiment may be applied to the head portion of the liquid phase film deposition chamber shown in Embodiment 2, and to the liquid phase film deposition chamber of FIG. 1. It may be used together with the liquid phase film deposition chamber of Embodiment 1.

### Embodiment 4

This embodiment describes a liquid phase film deposition chamber having a nozzle that is structured differently than the nozzles explained in Embodiment 3. FIG. 7A shows a nozzle standing by before and after application, and FIG. 7B shows the nozzle during the application operation. FIGS. 7C and 7D are cross sectional views of the nozzle, viewed from the above.

In FIG. 7A, reference numeral 701 denotes a nozzle, 702, a rod, and 703, an application solution. See Embodiments 2 and 3 for materials of the nozzle and the rod. The inner wall of the nozzle 701 may repel the application solution and the rod 702 may absorb the application solution.

The nozzle 701 of this embodiment has rod stopper portions 704a and 704b on its inner wall. The rod stopper portion 704a has in its center a hole for allowing the application solution to pass through. The rod 702 has a stopper portion 705, which has a diameter larger than the diameter of the hole formed in the rod stopper portion 704a.

In other words, the stopper portion 705 is caught on the rod stopper portion 704 as shown in FIG. 7A, so that the traveling path of the application solution 703 is blocked if the nozzle is standing by before and after application. Therefore the application solution 703 does not leek from the tip of the nozzle during the nozzle is standing by.

On the other hand, when the application solution is to be applied, a tip 706 of the rod 702 is brought into contact with a deposition target surface 707 and the rod 702 is pushed into the nozzle 701, as shown in FIG. 7B. Then the rod 702 is stopped with the stopper portion 705 being in contact with the rod stopper portion 704b. In this state, the application solution 703 slides down the rod 702 and flows out the nozzle to be applied to the deposition target surface 707.

The tip 706 of the rod is desirably spherical. The spherical tip can avoid damaging the deposition target surface 707.

Having the nozzle structured as above, the liquid phase film deposition chamber of this embodiment is capable of preventing leakage of the application solution without the suck back mechanism explained in Embodiment 2. Moreover, the film deposition chamber of this embodiment can make an EL element of high reliability by gettering oxygen in advance in accordance with the manner of the present invention. The structure of this embodiment may be applied to the head portion of the liquid phase film deposition chamber shown in Embodiment 2, and to the liquid phase film deposition chamber of FIG. 1. It may be used together with the liquid phase film deposition chamber of Embodiment 1.

### Embodiment 5

A description given in this embodiment is of an example in which the film deposition apparatus of FIG. 1 has a pre-processing chamber 110 provided with a mechanism for plasma processing. When a cathode surface of an EL element is pre-processed, a natural oxide is desirably removed from the surface of the cathode made of a metal. In this embodiment, the mechanism performs plasma processing on the cathode surface using gas that contains fluorine or chlorine to remove the natural oxide.

The structure of this embodiment may freely be combined with any structure of Embodiments 1 to 3.

### Embodiment 6

A description given in this embodiment is of an example in which the film deposition apparatus of FIG. 1 has a pre-processing chamber 110 provided with a sputtering mechanism. When a cathode surface of an EL element is pre-processed, a natural oxide is desirably removed from the surface of the cathode made of a metal. In this embodiment, the mechanism performs sputtering on the cathode surface using an inert gas such as rare gas or nitrogen to remove the natural oxide.

The structure of this embodiment may freely be combined with any structure of Embodiments 1 to 3.

### Embodiment 7

This embodiment shows an example of manufacturing a light emitting device (EL display device, to be specific) using the film deposition apparatus shown in FIG. 1.

First, TFTs are formed on a substrate by a known technique in order to form a pixel portion and a driver circuit portion. In this embodiment, the pixel portion and the driver circuit portion are formed on the same substrate using the technique disclosed by the applicant of the present invention in U.S. Pat. No. 6,023,308. A pixel electrode made of a transparent conductive film is electrically connected provided in a pixel TFT of the pixel portion to serve as an anode of an EL element.

The substrate with the TFT and the pixel electrode being completed (hereinafter referred to as active matrix substrate) is set in the stock chamber 105 of FIG. 1.

The active matrix substrate is then transferred to the pre-processing chamber 110, where the surface of the pixel electrode is pre-processed. In this embodiment, the superficial state of the pixel electrode is improved by being irradiated with ultraviolet light in an ozone atmosphere.

Then the active matrix substrate is transferred to the vapor phase film deposition chamber 111, so that a copper phthalocyanine film is formed by evaporation as a hole injection layer. The thickness of the film is 20 nm in this embodiment, but it is not particularly limited.

The active matrix substrate is once returned to the stock chamber 105 to transfer the active matrix substrate to the calcining chamber 108 by the transferring mechanism (B) 107. In the calcining chamber 108, the active matrix substrate is turned over so that the side on which the TFTs are formed faces upward.

Next, the turned over active matrix substrate is transferred to the liquid phase film deposition chamber 109 having the structure shown in FIGS. 2A and 2B. Note that the liquid phase film deposition chamber 109 may take any structure of Embodiments 1 to 4. An oxygen gettering agent (magnesium in this embodiment) is first oxidized in the oxidization cell 205 to reduce the oxygen concentration in the liquid phase film deposition chamber 109 to 1 ppb or less. Thereafter, a precursor of polyphenylene vinylene dissolved in dichloromethane is applied by spin coating.

The active matrix substrate coated with the precursor is transferred to the calcining chamber 108 where the precursor of polyphenylene vinylene is calcined. The precursor is thus polymerized to form a light emitting layer from the polyphenylene vinylene film. Upon completion of the calcining, the active matrix substrate is again turned over and returned to the stock chamber 105.

Next, the active matrix substrate is transferred to the vapor phase film deposition chamber 111 to form an aluminum film with a thickness of 400 nm by evaporation. This aluminum film also serves as a cathode of the EL element. The aluminum film to be used in this embodiment may be an aluminum alloy film containing titanium, scandium, or silicon. Instead of the aluminum film, a conductive film of copper, copper alloy, or silver may be used.

The active matrix substrate is then transferred to the sealing chamber 112 filled with an inert gas (nitrogen gas or rare gas). In the sealing chamber, a sealing material is formed on the active matrix substrate, and a covering member is bonded to the substrate such that the covering member covers the side on which the EL element has been formed. The EL element is thus sealed in an air-tight space filled with the inert gas so that the contact between the EL element and outside air is completely cut off. It is also possible to fill the space with a resin instead of the inert gas. In this case also, to place an absorbent substance in the resin is effective.

The active matrix substrate and the covering member are thus bonded to each other by the sealing material. Then the sealing material is irradiated with ultraviolet light using the ultraviolet light irradiation mechanism 113 to be cured. After the sealing processing of the EL element is completed in this way, the sealed active matrix substrate is transferred to the hand over chamber 114.

As has been described, the film deposition apparatus of the present invention is capable of conducting a process of from forming an EL element in an environment where oxygen content is minimized to completely cutting off the contact between the EL element and outside air, without an interruption.

The example shown in this embodiment is of a process of manufacturing an active matrix EL display device. However, this embodiment may be applied to a process of manufacturing a passive matrix EL display device. This embodiment may also be applied to a process of manufacturing a light emitting device for use as a backlight.

### Embodiment 8

This embodiment explains an example of manufacturing a light emitting device having a structure different from the one in Embodiment 6, using the film deposition apparatus shown in FIG. 1. The explanation in this embodiment is made taking as an example an active matrix EL display device.

First, a pixel portion and a driver circuit portion are formed on a substrate using the technique disclosed in U.S. Pat. No. 6,023,308. A conductive film containing aluminum or an aluminum alloy is used as a pixel electrode in this embodiment. That is, the pixel electrode in this embodiment serves as a cathode of an EL element.

After the active matrix substrate is completed, the active matrix substrate is set in the stock chamber 105 of FIG. 1.

The active matrix substrate is transferred to the pre-processing chamber 110 to pre-process the surface of the pixel electrode. In this embodiment, plasma processing is performed on the surface of the pixel electrode using gas that contains fluorine or chlorine to remove a natural oxide.

Then the active matrix substrate is transferred to the vapor phase film deposition chamber 111, where a lithium fluoride film is formed by evaporation as an electron injection layer. Although the thickness of the film is set to 20 nm in this embodiment, no particular limitation is put on the film thickness thereof.

Returning once the active matrix substrate to the stock chamber 105, the transferring mechanism (B) 107 transfers the active matrix substrate to the calcining chamber 108. The active matrix substrate is then turned over.

The turned over active matrix substrate is transferred to the liquid phase film deposition chamber 109 that has a structure shown in FIGS. 4A and 4B. An oxygen gettering agent (sodium, in this embodiment) is first oxidized in the oxidization cell 409 to reduce the oxygen concentration in the liquid phase film deposition chamber 109 to 1 ppb or less. Thereafter, a precursor of polyvinyl carbazole dissolved in toluene is applied by the application method shown in FIGS. 5A to 5C.

The active matrix substrate coated with the precursor is transferred to the calcining chamber 108, where the precursor of polyvinyl carbazole is calcined. The precursor is thus polymerized to form a light emitting layer from the polyvinyl carbazole film. Upon completion of the calcining, the active matrix substrate is again turned over and returned to the stock chamber 105.

Then the active matrix substrate is transferred to the vapor phase film deposition chamber 111 to form a copper phthalocyanine film with a thickness of 20 nm by evaporation, and to further form a transparent conductive film (specifically, a film containing a compound of indium oxide and zinc oxide) with a thickness of 200 nm by evaporation. This transparent conductive film functions as an anode of the EL element. The transparent conductive film used in this embodiment may instead be a film containing a compound of indium oxide and tin oxide.

The active matrix substrate is next transferred to the sealing chamber 112 filled with an inert gas (nitrogen gas or rare gas). In the sealing chamber, a sealing material is formed on the active matrix substrate and a covering member is bonded to the substrate so as to cover the side on which the EL element has been formed. The EL element is thus sealed in an air-tight space filled with the inert gas so that the contact between the EL element and outside air is completely cut off. It is also possible to fill the space with a resin instead of the inert gas. In this case also, to place an absorbent substance in the resin is effective.

The active matrix substrate and the covering member are thus bonded to each other by the sealing material. Then the sealing material is irradiated with ultraviolet light using the ultraviolet light irradiation mechanism 113 to be cured. After the sealing processing of the EL element is completed in this way, the sealed active matrix substrate is transferred to the hand over chamber 114.

As has been described, the film deposition apparatus of the present invention is capable of conducting a process of from forming an EL element in an environment where oxygen content is minimized to completely cutting off the contact between the EL element and outside air, without an interruption.

### Embodiment 9

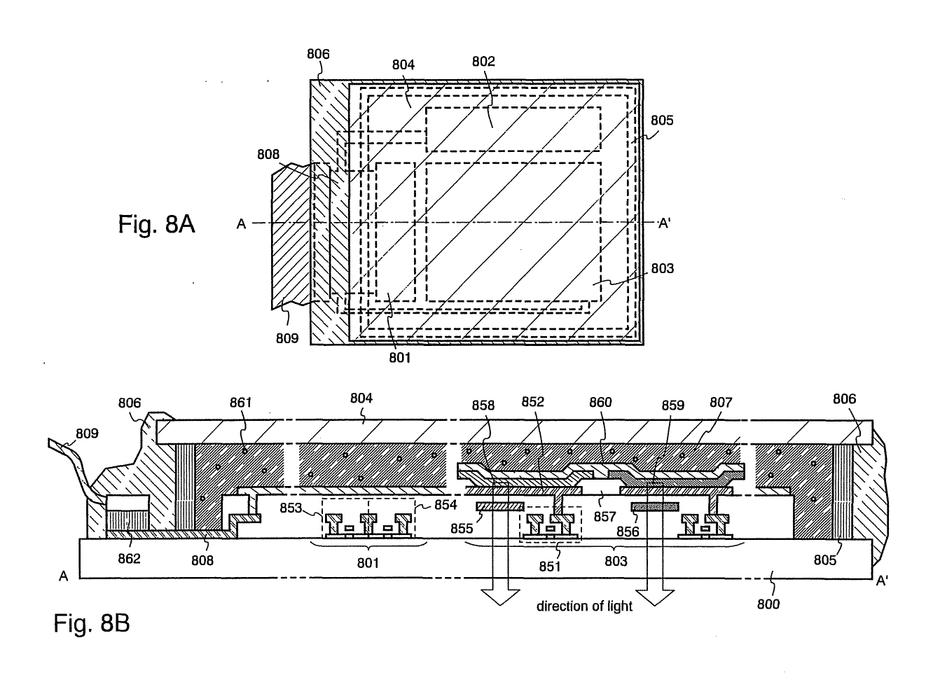

The active matrix type EL display device of the present invention will be explained in Embodiment 9 with reference to FIGS. 8A and 8B. FIG. 8A is a top view showing the state of the device in which sealing of the EL element formed on the active matrix substrate is completed. Indicated by dotted lines, reference numeral 801 denotes a source side driver circuit, 802 denotes a gate side driver circuit, and 803 denotes a pixel portion. Further, reference numeral 804 denotes a covering member, 805 denotes a first sealing member, and 806 denotes a second sealing member. A filler 807 (see FIG. 8B) is filled in a space, which is formed inside the sealed substrate, surrounded by the first sealing member 805 and between the covering member and the active matrix substrate.

Denoted by reference numeral 808 is a connecting wiring for transmitting a signal to be inputted to the source side driver circuit 801, the gate side driver circuit 802, and the pixel portion 803. The connecting wiring 808 receives a video signal and a clock signal from an FPC (Flexible Print Circuit) 809 serving as a connecting terminal to an external equipment.

Shown in FIG. 8B is a sectional view corresponding to the cross-section taken along the line A-A′ of FIG. 8A. In FIGS. 8A and 8B, the same reference numerals are used to denote the same components.

As shown in FIG. 8B, the pixel portion 803 and the source side driver circuit 801 are formed on a substrate 800. The pixel portion 803 is composed of a plurality of pixels each including a TFT 851 for controlling a current flow to an EL element (hereinafter referred to as a current controlling TFT) and a pixel electrode 852 that is electrically connected to the drain of the TFT 851. In this Embodiment, the current controlling TFT 851 is formed of the P-channel TFT. Furthermore, the source side driver circuit 801 is formed using a CMOS circuit in which an N-channel TFT 853 and a P-channel TFT 854 are complementarily combined.

Each of the pixels has a color filter (R) 855, a color filter (G) 856, and a color filter (B) (not shown) under the pixel electrode. The color filter (R) is a color filter for extracting red light, the color filter (G) is a color filter for extracting green light, and the color filter (B) is a color filter for extracting blue light. It is to be noted that the color filter (R) 855, the color filter (G) 856, and the color filter (B) are provided in a red emitting pixel, a green emitting pixel, and a blue emitting pixel, respectively.

First, improving the color purity of emitted light can be cited as an effect in the case of providing these color filters. For example, a red light is irradiated from an EL element that is from the red emitting pixel (light is irradiated in a direction toward the pixel electrode side in this Embodiment). The color purity of this red light can be improved by allowing this red light to pass through the color filter for extracting red light. This improvement in color purity by means of a color filter can be similarly applied to the other green and blue lights.

In a conventional structure without using the color filters, visible radiation penetrating from the exterior of the EL display device excites the light-emitting layer of the EL element, and therefore a problem occurs in which a desired color cannot be obtained. However, by providing color filters as in Embodiment 9, only light of a specific wavelength enters the EL element. In other words, the drawback of an external light exciting the EL element can be prevented.

Note that proposals to provide color filters in the structure have been made, however an EL element emitting white was used in the structure. In this case, the light of another wavelength was cut in order to extract the red light, resulting in inviting a reduction in luminance. Nevertheless, for example, because the red light emitted from the EL element is caused to pass through the color filter for extracting red light in Embodiment 9, there is no reduction in luminance.

Next, the pixel electrode 852 is formed of a transparent conductive film and functions as the anode of the EL element. An insulating film 857 is formed on each end of the pixel electrode 852 to thereby further form a light-emitting layer 858 emitting red light and a light-emitting layer 859 emitting green light. It is to be noted that a light-emitting layer emitting blue light not shown in the drawing is provided in an adjacent pixel. Color display is thus performed by the pixels that correspond to the colors red, green, and blue. The color filter for extracting the blue color is of course provided in the pixel in which the light-emitting layer emitting blue light is formed.

Note that the light emitting layers 858 and 859 are deposited using the film deposition apparatus shown in FIG. 1. Further, a liquid phase deposition room in which a light-emitting layer is substantially deposited may have any constitution of Embodiments 1 to 4. Not only an organic material but also an inorganic material can be used as the material of the light-emitting layers 858 and 859. Also note that, though the structure shown here is composed of only the light-emitting layer, it may be a laminate structure in which the light-emitting layer is combined with an electron injection layer, an electron transportation layer, a hole transportation layer, or a hole injection layer.

A cathode 860 of the EL element that is made of a conductive film having light shielding characteristics is formed on top of the respective light-emitting layers. The cathode 860 functions as a common wiring shared by all the pixels, and is electrically connected to the FPC 809 via the connecting wiring 808.

Next, the first sealing member 805 is formed using a dispenser or the like, and a spacer (not shown) is sprayed to bond the first sealing member to the covering member 804. The filler 807 is then filled into the space surrounded by the active matrix substrate, the covering member 804, and the first sealing member 805 by vacuum injection method.

In Embodiment 9, barium oxide as a moisture absorbent material 861 is added into the filler 807 in advance. Note that though the moisture absorbent material is added into the filler used in Embodiment 9, it can be massively dispersed and sealed within the filler. In addition, it is also possible to use a moisture absorbent material as the material of a spacer not shown in the drawing.

After curing the filler 807 with ultraviolet irradiation or heat, an opening portion (not shown) formed in the first sealing member 805 is sealed up. Upon sealing up the opening portion of the first sealing member 805, the connecting wiring 808 and the FPC 809 are electrically connected by using a conductive material 862. Then, the second sealing member 806 is disposed so as to cover the exposed portions of the first sealing member 805 and a portion of the FPC 809. The second sealing member 806 may be formed from the same material as the first sealing member 807.

By sealing the EL element within the filler 807 using the method as described above, the EL element is completely cut off from the outside and invasion from the outside by substances that accelerate the oxidation of the organic material, such as moisture and oxygen, can thus be prevented. Accordingly, an EL display device of high reliability can be manufactured.

Because the production line of existing liquid crystal display devices can be redirected by employing the present invention, a sharp reduction in the cost of maintenance investment is possible. A plurality of light-emitting devices can be fabricated from one piece of substrate through a process of high yield, resulting in making a substantial cutback in manufacturing cost.

Note that the EL display device of this embodiment may freely be combined with any structure of Embodiments 1 to 7.

### Embodiment 10

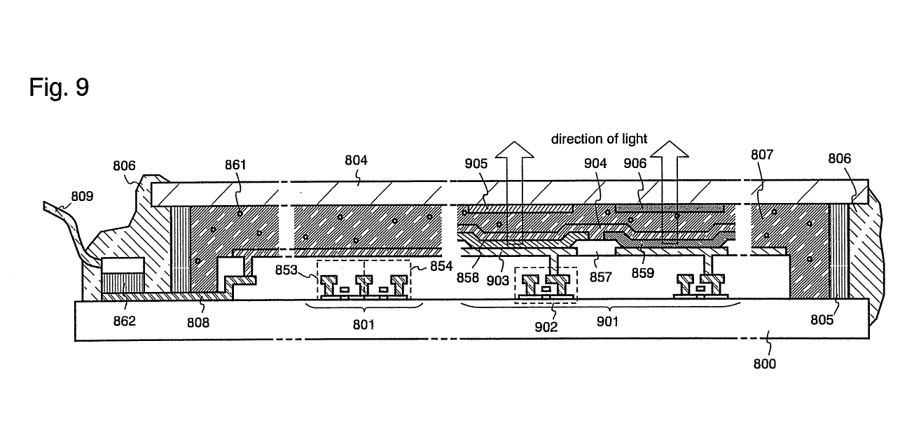

Shown in Embodiment 10 is an example of a case in which the emission direction of the light emitted from the EL element and the arrangement of the color filters in the EL display device shown in Embodiment 9 are different. Though the explanation thereof will be made with reference to FIG. 9, the basic structure is the same as that of FIG. 8B and therefore common reference numerals are used but only the modified components are denoted by new reference numerals and explained.

In Embodiment 10, the N-channel TFT is used as a current controlling TFT 902 in a pixel portion 901. A pixel electrode 903 that is formed of a conductive film having a light shielding characteristic is electrically connected to a drain of the current controlling TFT 902. The pixel electrode 903 serves as the cathode of the EL element in Embodiment 10.

A transparent conductive film 904 which functions as a common conductive film shared by respective pixels is formed on the light-emitting layer 858 emitting red light and the light-emitting layer 859 emitting green light, which are formed by using the present invention. The transparent conductive film 904 serves as the anode of the EL element.

In addition, according to Embodiment 10, a color filter (R) 905, a color filter (G) 906, and a color filter (B) (not shown) are formed on the covering member 804. In the case of adopting the structure of the EL element of Embodiment 10, the light emitted from the light-emitting layer is in the direction towards the covering member side. Therefore, by adopting the structure of FIG. 9, the color filters can be installed in the places of the paths of the light.

The manufacturing steps of the active matrix substrate can be reduced by providing the color filter (R) 905, the color filter (G) 906, and the color filter (B) (not shown) on the covering member 804 as in Embodiment 10. Consequently, merits such as improvement in yield and throughput can be attained.

Note that the EL display device of this embodiment may freely be combined with any structure of Embodiments 1 to 8.

The film deposition apparatus according to the present invention is capable of limiting the degradation of a light emitting layer formed from an EL material to a minimum, thereby enhancing the reliability of an EL element. The present invention thus makes it possible to greatly improve the reliability of a light emitting device that uses the EL element.

What is claimed is:

1. A film deposition apparatus comprising:
a stock chamber for loading or unloading a substrata;
a transferring chamber including a mechanism for transferring said substrate; and
a liquid phase film deposition chamber connected to said transferring chamber through a gate,
wherein said liquid phase film deposition chamber is provided with a mechanism for oxidizing an element belonging to Group 1 or 2 of the periodic table.

2. A film deposition apparatus according to claim 1, wherein an inside of said transferring chamber is kept under a reduced pressure and said liquid phase film deposition chamber is filled with an inert gas and is kept under atmospheric pressure or in a pressurized state.

3. A film deposition apparatus according to claim 1, wherein said transferring chamber is connected to a calcining chamber through a gate, and said calcining chamber is provided with a mechanism for turning said substrate upside down.

4. A film deposition apparatus comprising:
a stock chamber for loading or unloading a substrate;
a transferring chamber including a mechanism for transferring the substrate; and
a liquid phase film deposition chamber connected to said transferring chamber through a gate,
wherein said liquid phase film deposition chamber is provided with, via a piping, a mechanism for oxidizing an element belonging to Group 1 or 2 of the periodic table.

5. A film deposition apparatus according to claim 4, wherein an inside of said transferring chamber is kept under a reduced pressure and said liquid phase film deposition chamber is filled with an inert gas and is kept under atmospheric pressure or in a pressurized state.

6. A film deposition apparatus according to claim 4, wherein said transferring chamber is connected to a calcining chamber through a gate, and said calcining chamber is provided with a mechanism for turning said substrate upside down.

7. A film deposition apparatus comprising:
a stock chamber for loading or unloading a substrate;
two transferring chambers each connected to said stock chamber through a gate;
a vapor phase film deposition chamber connected to one of said two transferring chambers through a gate; and
a liquid phase film deposition chamber connected to another said transferring chamber through a gate,
wherein said liquid phase film deposition chamber is provided with a mechanism for oxidizing an element belonging to Group 1 or 2 of the periodic table.

8. A film deposition apparatus according to claim 7, wherein an inside of said transferring chamber is kept under a reduced pressure and said liquid phase film deposition chamber is filled with an inert gas and is kept under atmospheric pressure or in a pressurized state.

9. A film deposition apparatus according to claim 7, wherein said transferring chamber is connected to a calcining chamber through a gate, and said calcining chamber is provided with a mechanism for turning said substrate upside down.

10. A film deposition apparatus comprising:
a stock chamber for loading or unloading a substrate;
two transferring chambers each connected to said stock chamber through a gate;
a vapor phase film deposition chamber connected to one of said two transferring chambers through a gate; and
a liquid phase film deposition chamber connected to another said transferring chamber through a gate,
wherein said liquid phase film deposition chamber is provided with, via a piping, a mechanism for oxidizing an element belonging to Group 1 or 2 of the periodic table.

11. A film deposition apparatus according to claim 10, wherein an inside of said transferring chamber is kept under a reduced pressure and said liquid phase film deposition chamber is filled with an inert gas and is kept under atmospheric pressure or in a pressurized state.

12. A film deposition apparatus according to claim 10, wherein said transferring chamber is connected to a calcining chamber through a gate, and said calcining chamber is provided with a mechanism for turning said substrate upside down.

13. A film deposition apparatus comprising:
a stock chamber for loading or unloading a substrata;
a transferring chamber for transferring said substrate; and
an EL material deposition chamber connected to said transferring chamber through a gate,
wherein said EL material deposition chamber is provided with a cell which contains an element belonging to Group 1 or 2 of the periodic table.

14. A film deposition apparatus according to claim 13, wherein an inside of said transferring chamber is kept under a reduced pressure and said EL material deposition chamber is filled with an inert gas and is kept under atmospheric pressure or in a pressurized state.

15. A film deposition apparatus according to claim 13, wherein said transferring chamber is connected to a calcining chamber through a gate, and said calcining chamber is provided with a mechanism for turning said substrate upside down.

16. A film deposition apparatus comprising:
a stock chamber for loading or unloading a substrate;
two transferring chambers each connected to said stock chamber through a gate;
a vapor phase film deposition chamber connected to one of said two transferring chambers through a gate; and
an EL material deposition chamber connected to another said transferring chamber through a gate,
wherein said EL material deposition chamber is provided with a cell which contains an element belonging to Group 1 or 2 of the periodic table.

17. A film deposition apparatus according to claim 16, wherein an inside of said transferring chamber is kept under a reduced pressure and said EL material deposition chamber is filled with an inert gas and is kept under atmospheric pressure or in a pressurized state.

18. A film deposition apparatus according to claim 16, wherein said transferring chamber is connected to a calcining chamber through a gate, and said calcining chamber is provided with a mechanism for turning said substrate upside down.

19. A method of manufacturing a light emitting device, comprising the steps of:
transferring a substrate over which a plurality of pixel electrodes are formed into a liquid phase film deposition chamber;
sealing said liquid phase film deposition chamber air-tight to oxidize an element belonging to Group 1 or 2 of the periodic table in said chamber; and
forming a film which contains an organic EL material over said substrate.

20. A method of manufacturing a light emitting device according to claim 19, wherein a spin coating method, a printing method, an ink jet method, or a dispensing method is used in forming said film which contains said organic EL material.

21. A method of manufacturing a light emitting device according to claim 19, wherein said film which contains said organic EL material is formed in an atmosphere having an oxygen concentration of 1 ppb or less.

22. A method of manufacturing a light emitting device, comprising the steps of:
transferring a substrate over which a plurality of pixel electrodes are formed into a liquid phase film deposition chamber;
sealing said liquid phase film deposition chamber air-tight to oxidize an element belonging to Group 1 or 2 of the periodic table in said chamber;
forming a film which contains an organic EL material over said substrate; and
transferring said substrate over which said film has been formed into a vapor phase film deposition chamber to form a conductive film thereon.

23. A method of manufacturing a light emitting device according to claim 22, wherein a spin coating method, a printing method, an ink jet method, or a dispensing method is used in forming said film which contains said organic EL material.

24. A method of manufacturing a light emitting device according to claim 22, wherein said film which contains said organic EL material is formed in an atmosphere having an oxygen concentration of 1 ppb or less.

25. A method of manufacturing a light emitting device, comprising the steps of:
transferring a substrate over which a plurality of pixel electrodes are formed into an EL material deposition chamber, said chamber comprising a cell which contains an element belonging to Group 1 or 2 of the periodic table;
sealing said EL material deposition chamber air-tight to oxidize said element belonging to Group 1 or 2 of the periodic table; and
forming an EL layer over said pixel electrodes.

26. A method of manufacturing a light emitting device according to claim 25, wherein a spin coating method, a printing method, an ink jet method, or a dispensing method is used in forming said film which contains said organic EL material.

27. A method of manufacturing a light emitting device according to claim 25, wherein said EL layer is formed in an atmosphere having an oxygen concentration of 1 ppb or less.

28. A method of manufacturing a light emitting device, comprising the steps of:
transferring a substrate over which a plurality of pixel electrodes are formed into an EL material deposition chamber, said EL material deposition chamber comprising a cell which contains an element belonging to Group 1 or 2 of the periodic table;
sealing said EL material deposition chamber air-tight to oxidize said element belonging to Group 1 or 2 of the periodic table;
forming an EL layer over said pixel electrodes; and
transferring said substrate over which said EL film has been formed into a vapor phase film deposition chamber to form a conductive film thereon.

29. A method of manufacturing a light emitting device according to claim 28, wherein a spin coating method, a printing method, an ink jet method, or a dispensing method is used in forming said film which contains said organic EL material.

30. A method of manufacturing a light emitting device according to claim 28, wherein said EL layer is formed in an atmosphere having an oxygen concentration of 1 ppb or less.
